(19) United States
(12) Patent Application Publication
(10) Pub. No.: US 2007/0197211 A1
(43) Pub. Date: Aug. 23, 2007

(54) Method and apparatus for determining a system in a mobile terminal

(75) Inventors: Jong-Suk Lee, Suwon-si (KR); Seo-Won Heo, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/698,784

(22) Filed: Jan. 26, 2007

(30) Foreign Application Priority Data
Jan. 26, 2006 (KR) 2006-8309

(51) Int. Cl. H04Q 7/20

(52) U.S. Cl. 455/432.1

(57) ABSTRACT

A system determination method and apparatus are provided which can again acquire a system in a shortened time when a mobile terminal has lost an acquired system in a weak electric field area. When power is applied, the terminal reads system information of an acquisition table of a preferred roaming list and system information of a most recently used (MRU) table from a memory and generates a search list using the read information. The terminal determines whether a ping counter is applied through the generated search list. If the ping counter is applied, the terminal determines whether a ping counter value is equal to a maximum ping counter value. If the ping counter value is equal to the maximum ping counter value, the terminal initializes the ping counter value, selects a system from the MRU table and makes a system acquisition attempt.

### PRIORITY

This application claims the benefit under 35 U.S.C. § 119(a) of a Korean Patent Application filed in the Korean Intellectual Property Office on Jan. 26, 2006 and assigned Serial No. 2006-08309, the disclosure of which is incorporated herein by reference.

### BACKGROUND OF THE INVENTION

1. Field of the Invention

The present invention generally relates to a mobile terminal, and in particular, to a method and apparatus for determining a system in a mobile terminal.

2. Description of the Related Art

Mobile communication systems are being rapidly developed. In particular, third generation (3G) mobile communication systems have been developed to provide data at higher speed due to an increasing amount of data served in the existing mobile communication systems. These 3G mobile communication systems include a wideband-code division multiple access (W-CDMA) system which serves as an asynchronous system between base stations in Europe and a CDMA-2000 system which serves as a synchronous system between base stations in North America. Both W-CDMA and CDMA-2000 are currently being standardized as the wireless access standards. Conventional mobile communication systems typically have a structure in which user mobile terminals communicate with each other through one base station.

With the development of technologies, these mobile communication systems are provided with various communication schemes of advanced mobile phone service (AMPS), CDMA, global system for mobile communication (GSM), general packet radio service (GPRS), W-CDMA, and the like. Various systems are designed to co-exist according to their corresponding communication schemes and frequency bands on a communication provider-by-communication provider basis.

A communication provider provides a mobile terminal with information required for system acquisition through a preferred roaming list (PRL). Further, the mobile terminal acquires a system using the information transmitted through the PRL.

The PRL is used primarily when the mobile terminal selects and maintains a system (or base station) and performs a roaming process. The PRL is divided into an acquisition table and a system table. The acquisition table includes a system acquisition type, a frequency band class and channel information and the system table includes a system identifier (SID), a network identifier (NID), system availability information (PREF_NEG), geographic information (GEO), a priority (PRI), an acquisition index, a roaming indicator, and the like.

FIG. 1 is a flow diagram illustrating a system determination method for use in a conventional mobile terminal.

Here, when the mobile terminal is first powered up and a power up indication is generated in step 100, the mobile terminal reads a most recently used (MRU) table(s) corresponding to MRU system information and a PRL(s) corresponding to system information included in an acquisition table from an electrically erasable programmable read only memory (EEPROM) in step 101.

Then the mobile terminal generates one search list according to predefined search scenario in step 102 and then sequentially makes a system acquisition attempt in step 103. When power is applied, an initial search sequence is as follows:

1. MRU system

2. System present in the acquisition table of the PRL

The search list is a frequency list to be referenced when a system is searched for. The search list may be uniquely configured. A configuration method is a search scenario to be described below. After power is applied, a scenario is provided when an acquired system is lost.

The number of systems to be registered in the MRU table may be differently defined and used between communication providers. When the search list is registered, a system duplicated between the MRU table and the acquisition table of the PRL may not be registered later on.

After step 103, the mobile terminal then determines whether the system acquisition has succeeded in step 104. If the system acquisition has not succeeded, the mobile terminal increments a current search index value of the search list in step 109 and then returns to step 103. The current search index value is incremented in order to attempt to acquire the next system in an already configured search scenario.

However, if the system acquisition has succeeded, the mobile terminal receives a synchronous channel message (SCHM) and an overhead message (OVHD) in step 106. The mobile terminal compares the information of the system table of the PRL with the information of a SID/NID received in system parameter message (SPM) and SCHM fields in step 107. The mobile terminal determines whether the received SID/NID information matches the information of the system table of the PRL, that is, a SID/NID. If the received SID/NID information matches that of the system table of the PRL, it means that the received SID/NID indicates an available system.

Consequently, if the received SID/NID information is different from that of the system table of the PRL, the mobile terminal proceeds to step 109 to increment the current search index value of the search list and then returns to step 103. However, if the received SID/NID information matches that of the system table of the PRL, the mobile terminal enters an idle state and provides a service in step 110. When a handoff occurs or an overhead message sequence is changed in the idle state, the mobile terminal returns to sep 106 to again receive all overhead messages.

If the mobile terminal enters the idle state and provides the service in step 110, a call is performed in step 113.

If the call is terminated while the call is performed, the mobile terminal generates a call release indication in step 114. In step 115, the mobile terminal attempts to again acquire a system acquired before the call is released and after an initialization process.

If an abnormal state occurs while the service is provided in step 110, the mobile terminal attempts to acquire the next system in the already configured search scenario or makes a system acquisition attempt in a new search scenario. When the search scenario is mostly configured, the search scenario is configured in the same sequence as when initial power is applied. To shorten an acquisition time in the abnormal state, a search system sequence may be changed. A representative example is the case where a system lost indication is generated when an already acquired system is lost in step 111. In this case, a search list is generated using the MRU table and the PRL in step 112. At this time, a search sequence is configured as follows:

1. System included in the same area as a previously acquired system within the acquisition table of the PRL

2. MRU system

3. PRL system of the remaining area

An area of the previously acquired system may be detected using geographic information within the system table of the PRL. Systems to be first listed using acquisition index information of systems belonging to the same area are included in a search list to be newly configured. Here, the list is configured in which duplicated channels already included are excluded.

When a communication provider provides a multimode or multiband scheme or an amount of system information is large due to a wide service area, a size of the acquisition table of the PRL increases and therefore a size of the search list to be configured increases. When the mobile terminal is initially powered up and the search list is configured with an MRU system and the acquisition table of the PRL, a service may be conventionally immediately provided by the MRU system even though a size of the search list is large. However, when the abnormal state occurs in a state in which a system has been acquired, the following problems may occur:

1. In the case where an attempt is made to acquire the next system in an already configured search scenario

FIG. 2 illustrates an example of a conventional system search scheme when system acquisition fails. A problem occurs when an attempt is made to acquire the next system in the already configured search scenario and in a state in which the system acquisition fails.

If the number of systems is small in the configured search scenario, there is no special problem since the possibility of immediately acquiring a system is high when a search is performed from the beginning of the search scenario even though the acquisition fails after attempting to search for all the remaining systems in the configured search scenario. If the number of systems in the configured search scenario is very large or the search scenario is configured with systems incapable of being acquired in a current area, a ‘No Service’ state is maintained for a long time. In this case, there is a problem in that an antenna bar is changed to a state in which the mobile terminal is out of a service area as indicated by reference numeral 207 and a call attempt cannot be made in the ‘No Service’ state for the long time.

FIG. 2 illustrates an example in which power is applied and a search list is configured with three systems of the MRU table and systems of the acquisition table of the remaining PRL. It is assumed that the three systems of the MRU table are those previously acquired by the mobile terminal and are duplicated as System Nos. 1, 2 and 3 of the acquisition table of the PRL. Further, it is assumed that the mobile terminal located in a weak electric field area can provide only a service of System No. 3 of the MRU table.

In step 201, when the mobile terminal is powered up, the mobile terminal generates a search list with the systems of the MRU table and the PRL systems, acquires the third system of the MRU table by making a system acquisition attempt in sequence, and receives a service. When a phone call is made and terminated, the mobile terminal returns to an initialization state and makes an attempt to again acquire a previously acquired system.

In step 203, the attempt to again acquire the previously acquired system is made when the call is made and terminated. However, system acquisition fails due to an unstable signal level of the mobile terminal in the weak electric field area. In this case, the next system is searched for in the existing search scenario.

In step 205, acquisition fails for all other systems of the currently configured search list since any system other than System No. 3 of the MRU table cannot be acquired in the current area. In this case, an icon indicating a communication disabled state is displayed on a screen of the mobile terminal when the ‘No Service’ state continues for a predetermined time. This case is illustrated in image 207 of the mobile terminal.

In step 209, a search attempt is again made from the beginning of the search list when system acquisition based on the search list has completely failed.

In step 211, System No. 3 of the MRU table is again acquired when the search attempt is made from the beginning of the search list and the signal level state is good. As the number of acquisition systems of the PRL increases, the duration of the ‘No Service’ state may increase.

2. In the case where a new search scenario is configured and a system acquisition attempt is made

FIG. 3 illustrates an example of a conventional system search scheme when a system is continuously lost. A problem occurs when a new search scenario is configured and a system acquisition attempt is made due to a system lost indication after an acquired system is lost.

If the new search scenario is mostly configured, a system may be quickly acquired. However, when the same problem continuously occurs and the search scenario is successively generated, a search scenario may be newly generated in a state in which the remaining systems of a previously generated search scenario are not searched for. Thus there is a problem in that a service may not be smoothly continuously received in an associated area.

As in FIG. 2, FIG. 3 illustrates an example in which power is applied and a search list is configured with three systems of the MRU table and systems of the acquisition table of the remaining PRL. It is assumed that the three systems of the MRU table are those previously acquired by the mobile terminal and are duplicated as System Nos. 1, 2 and 3 of the acquisition table of the PRL. In an associated area, System No. 3 of the MRU table and System Nos. 4 and 5 of the PRL capable of providing services belong to the same area.

In step 301, the mobile terminal generates a search list with systems of the MRU table and PRL systems when power is applied to the mobile terminal, acquires System No. 3 of the MRU table by making a system acquisition attempt in sequence, and receives a service.

In step 303, a search list is reconfigured and a system acquisition attempt is made from the first system of the list when a system lost indication is generated after an acquired system is lost.

In step 305, System No. 3 of the MRU table is again searched for. Here, when System No. 3 of the MRU table is not acquired, the next system is searched for. However, System No. 3 of the MRU table is again acquired. When the system lost indication is generated after System No. 3 of the MRU table is again acquired, the search list is again reconfigured and the same operation is repeated.

There is a problem in that a service cannot be smoothly provided since only a previously acquired system is searched for although another system can normally provide the service when a state of the other system is better.

### SUMMARY OF THE INVENTION

An object of the present invention is to address at least the above problems and/or disadvantages and to provide at least the advantages described below. Accordingly, an object of the present invention is to provide a system determination method and apparatus for use in a mobile terminal that can again acquire a system in a shortened time when the mobile terminal has lost an acquired system or system acquisition in a situation such as, for example, a weak electric field area, by improving a conventional system search scheme.

An object of the present invention is to provide a system determination method and apparatus that can efficiently select a system in a mobile terminal.

An object of the present invention is to provide a system determination method and apparatus for use in a mobile terminal that can perform an efficient system search by introducing a ping search concept to periodically search for systems of a most recently used (MRU) table.

An object of the present invention is to provide a system determination method and apparatus that can reduce a probability of occurrence of a ‘No Service’ state by periodically frequently searching for systems since a possibility of again acquiring systems of an MRU table from which a service has been previously provided is high when a system search is performed using an already configured search list or a search list of a new search scenario due to an abnormal state occurred in a mobile terminal.

According to another aspect of the present invention, there is provided a method for determining a system in a mobile terminal, including reading system information included in an acquisition table of a preferred roaming list (PRL) and MRU system information included in an MRU table from a memory when power is applied to the mobile terminal, and generating a search list using the read information; determining whether a ping counter is applied through the generated search list; determining whether a ping counter value is equal to a maximum ping counter value if the ping counter is applied; and initializing the ping counter value, selecting a system from the MRU table and making a system acquisition attempt, if the ping counter value is equal to the maximum ping counter value.

According to another aspect of the present invention, there is provided a method for determining a system in a mobile terminal including determining whether a previously lost system is equal to a currently lost system when the mobile terminal has lost a system; setting a ping search, initializing a ping counter and setting a maximum ping counter value, if the previously lost system is equal to the currently lost system; determining whether the ping counter is applied through a previously configured search list; determining whether a ping counter value is equal to the maximum ping counter value if the ping counter is applied; and initializing the ping counter value, selecting a system from an MRU table and making a system acquisition attempt, if the ping counter value is equal to the maximum ping counter value.

According to another aspect of the present invention, there is provided a method for determining a system in a mobile terminal including setting a ping search, initializing a ping counter value and setting a maximum ping counter value, when a call of the mobile terminal is terminated; and attempting to again acquire a previously acquired system.

According to another aspect of the present invention, there is provided an apparatus for determining a system in a mobile terminal, including a controller for reading system information included in an acquisition table of a PRL and MRU system information included in an MRU table from a memory when power is applied to the mobile terminal, generating a search list using the read information, determining whether a ping counter is applied through the generated search list, determining whether a ping counter value is equal to a maximum ping counter value if the ping counter is applied, and initializing the ping counter value, selecting a system from the MRU table and making a system acquisition attempt, if the ping counter value is equal to the maximum ping counter value.

According to another aspect of the present invention, there is provided an apparatus for determining a system in a mobile terminal, including: a controller for determining whether a previously lost system is equal to a currently lost system when the mobile terminal has lost a system, setting a ping search, initializing a ping counter and setting a maximum ping counter value, if the previously lost system is equal to the currently lost system, determining whether the ping counter is applied through a previously configured search list, determining whether a ping counter value is equal to the maximum ping counter value if the ping counter is applied, and initializing the ping counter value, selecting a system from an MRU table and making a system acquisition attempt, if the ping counter value is equal to the maximum ping counter value.

According to another aspect of the present invention, there is provided an apparatus for determining a system in a mobile terminal including a controller for setting a ping search, initializing a ping counter value and setting a maximum ping counter value, when a call of the mobile terminal is terminated, and attempting to again acquire a previously acquired system.

### BRIEF DESCRIPTION OF THE DRAWINGS

The above and other features and advantages of the present invention will be more apparent from the following detailed description taken in conjunction with the accompanying drawings, in which:

FIG. 1 is a flow diagram illustrating a system acquisition method for use in a conventional mobile terminal;

FIG. 2 illustrates an example of a conventional system search scheme when system acquisition fails;

FIG. 3 illustrates an example of a conventional system search scheme when a system is continuously lost;

FIGS. 4A and 4B are a flow diagram illustrating a system determination method for use in a mobile terminal in accordance with the present invention;

FIG. 5 illustrates a structure of a most recently used (MRU) table in accordance with the present invention;

FIGS. 6A and 6B illustrate an example of reordering the MRU table in accordance with the present invention;

FIG. 7 illustrates an example of a system search scheme when system acquisition fails in accordance with the present invention;

FIG. 8 illustrates an example of a system search scheme when a system is continuously lost in accordance with the present invention; and

FIG. 9 is a block diagram illustrating a system determination apparatus for use in a mobile terminal in accordance with the present invention.

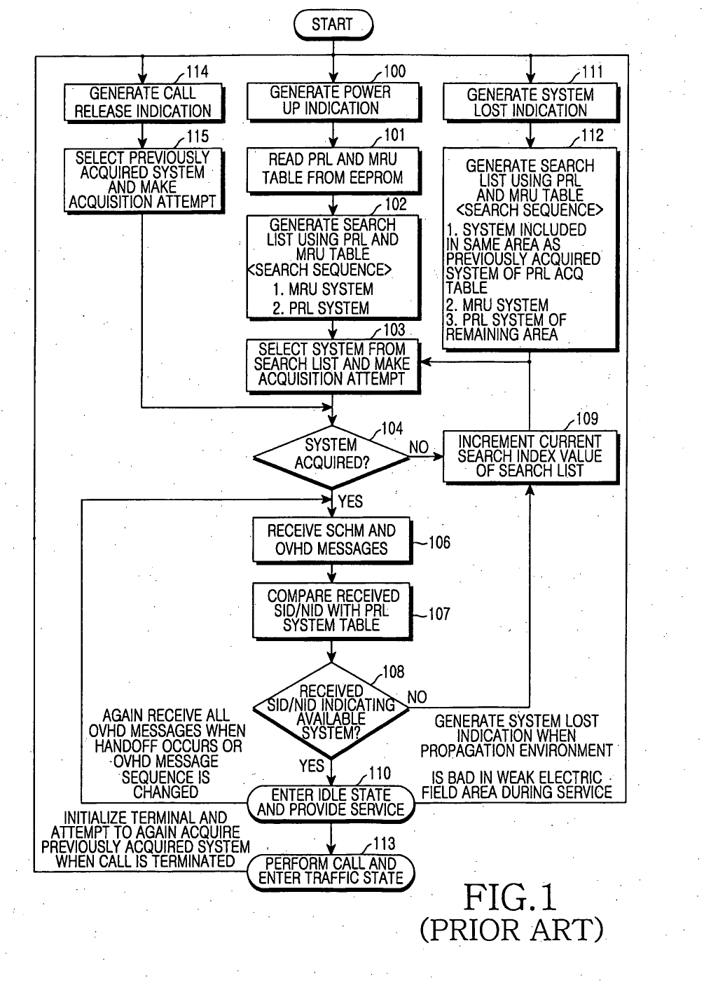

### DETAILED DESCRIPTION OF PREFERRED EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Preferred embodiments of the present invention can perform an efficient system search by introducing a ping search concept in which values of a most recently used (MRU) table are inserted into a search sequence.

Moreover, other embodiments of the present invention can reduce a probability of occurrence of a ‘No Service’ state by periodically frequently searching for systems since the possibility of again acquiring systems of the MRU table from which a service has been previously provided is high when a system search is performed using an already configured search list or a search list of a new search scenario due to an abnormal state occurred in a mobile terminal. Most recently updated information is used in the systems of the MRU table. When a ping search is applied, a sequence is reordered such that systems belonging to the same area as a previously acquired system can be first searched for. A maximum value of a ping counter is set by computing a time when a difference from a time required to search for all systems of the search list is minimized in the case where the ping search is disabled by considering the number of systems of the search list configured with a preferred roaming list (PRL) and the number of systems registered in the MRU table. If the number of system registered in the MRU table is absent, the ping search is disabled.

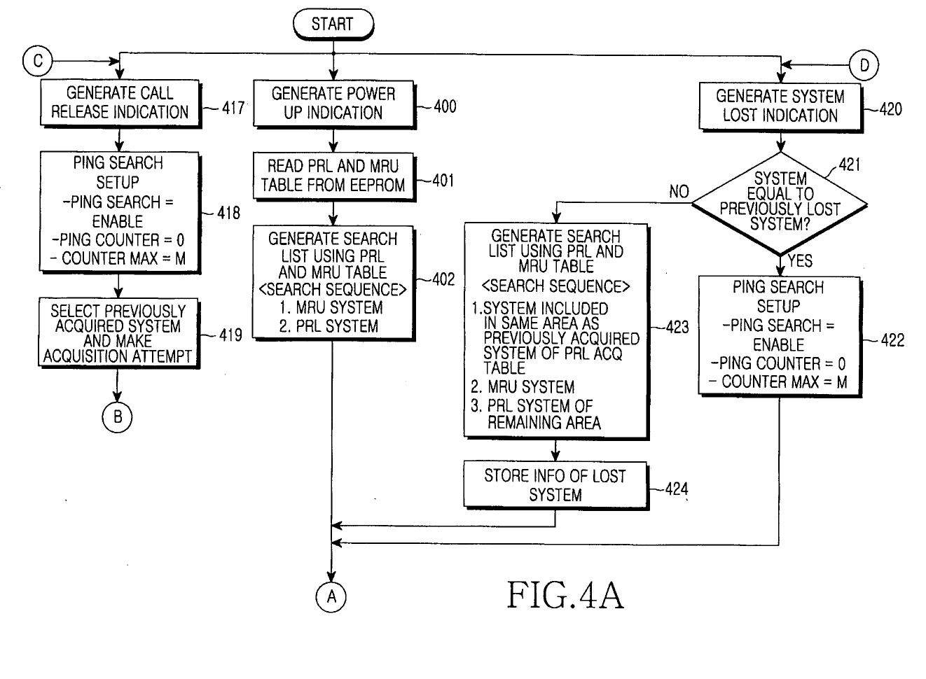

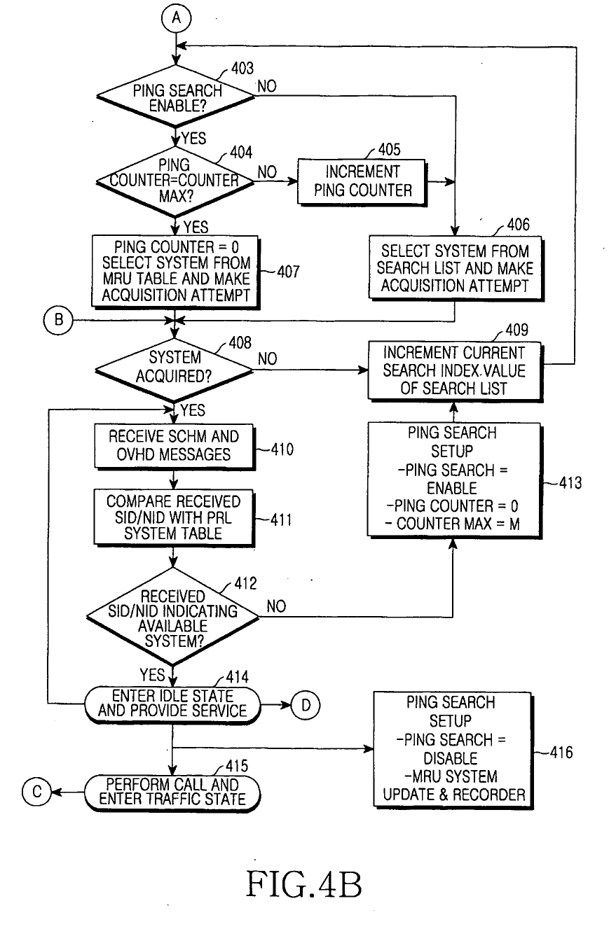

FIGS. 4A and 4B are a flow diagram illustrating a system determination method for use in a mobile terminal in accordance with the present invention. 4A and 4B.

When the mobile terminal is powered up in step 400, the mobile terminal reads system information included in an acquisition table of the PRL and MRU system information included in an MRU table from an electrically erasable programmable read only memory (EEPROM) in step 401. Then the mobile terminal generates one search list according to predefined search scenario in step 402. When power is applied, an initial search sequence is as follows:

1. MRU system

2. System present in the acquisition table of the PRL

After the search list is generated in step 402, the mobile terminal determines whether a ping search is applied in step 403. This determination is made using a ping search flag value. When initial power-up is performed, the ping search flag value is initialized to a ‘disable’ value. When an abnormal state occurs as in steps 413, 418 and 422 of FIGS. 4A and 4B, the ping search flag value is set to an ‘enable’ value, and the ping search is applied when the next step of the search is performed. If the ping search is not applied, the mobile terminal selects a system from the search list and makes a system acquisition attempt in step 406. However, if the ping search is applied, the mobile terminal determines whether a current ping counter value is equal to a maximum ping counter value in step 404. If the current ping counter value is equal to the maximum ping counter value, the mobile terminal initializes the ping counter value, selects a system from an updated MRU table, and makes a system acquisition attempt in step 407. However, if the current ping counter value is less than the maximum value, the mobile terminal increments the ping counter in step 405 and then goes to step 406 to select a system from the search list and make an acquisition attempt.

While the system acquisition attempt is made in step 407, the mobile terminal determines whether the system acquisition is successful in step 408. If the system acquisition is unsuccessful, the mobile terminal increments a current search index value of the search list in step 409 and then goes to step 403. However, if the system acquisition is successful, the mobile terminal receives a synchronous channel message (SCHM) and an overhead message (OVHD) in step 410.

In step 411, the mobile terminal compares information of a system table of the PRL with information of a system identifier/network identifier (SID/NID) received in system parameter message (SPM) and SCHM fields.

In step 412, the mobile terminal determines whether the received SID/NID information matches the information of the system table of the PRL, that is, an SID/NID. If the received SID/NID information matches that of the system table of the PRL, it means that the received SID/NID indicates an available system.

If the received SID/NID information matches that of the system table of the PRL, the mobile terminal provides a service in step 414. However, if the received SID/NID information is different from that of the system table of the PRL, the mobile terminal applies (or sets) the ping search, initializes the ping counter value and sets the maximum ping counter value in step 413. Then the mobile terminal increments the current search index value of the search list in step 409. The current search index value is incremented in order to attempt to acquire the next system of an already configured search scenario. When normally entering an idle state in step 414, the mobile terminal sets the ping search to be disabled, updates information of the MRU table and reorders a sequence of geographic information using the information of the system table of the currently acquired PRL in step 416.

When the service is provided in step 414, the mobile terminal performs a call in step 415. When the call is terminated while the call is being performed in step 415, the mobile terminal generates a call release indication in step 417. The mobile terminal applies (or sets) the ping search, initializes the ping counter value and sets the maximum ping counter value in step 418. Then the mobile terminal attempts to again acquire a system acquired before call release and after an initialization process in step 419. Then the mobile terminal proceeds to step 408.

If an abnormal state occurs in operation, the mobile terminal performs a system selection and acquisition process in the already configured search scenario or a newly configured search scenario. When the search scenario is mostly configured, the search scenario is configured in the same sequence as when initial power is applied. To shorten an acquisition time in the abnormal state, a search system sequence can be changed. A representative example is the case where a system lost indication is generated when an already acquired system is lost in step 420. In this case, a new search list is not configured according to search scenario. In step 421, the mobile terminal determines whether a previously lost system is equal to a currently lost system. If the previously lost system is equal to the currently lost system, the mobile terminal applies (or sets) the ping search, initializes the ping counter value and sets the maximum ping counter value in step 422. However, if the previously lost system is different from the currently lost system, the mobile terminal generates a search list using the MRU table and the PRL in step 423. At this time, a search sequence is configured as follows:

1. System included in the same area as a previously acquired system within the acquisition table of the PRL

2. MRU system

3. PRL system of the remaining area

After step 423, the mobile terminal stores information of a lost system in step 424. The information of the lost system is stored in a storage space different from that of the search list. This information is used for a comparison between lost systems in step 421. After steps 424 and 422 are completed, the mobile terminal proceeds to step 403.

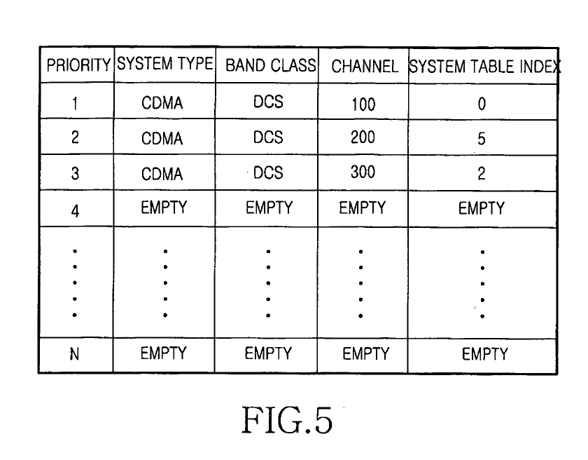

FIG. 5 illustrates a structure of the MRU table in accordance the present invention.

The MRU table is constructed with a system type, a frequency band class, a channel, and a system table index on the horizontal axis and a priority on the vertical axis.

The MRU table of FIG. 5 has a structure in which a system table index value of the PRL is stored in addition to a material structure of the conventional MRU table. Geographic information is included in a system table. Using the geographic information, a search sequence can be reordered such that systems registered in the MRU table belonging to the same area as a most recently acquired system are first searched for.

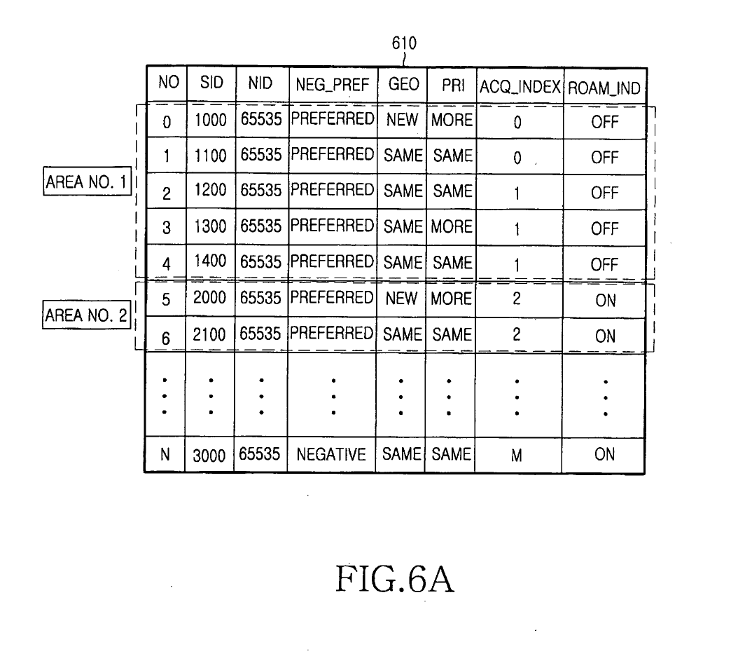

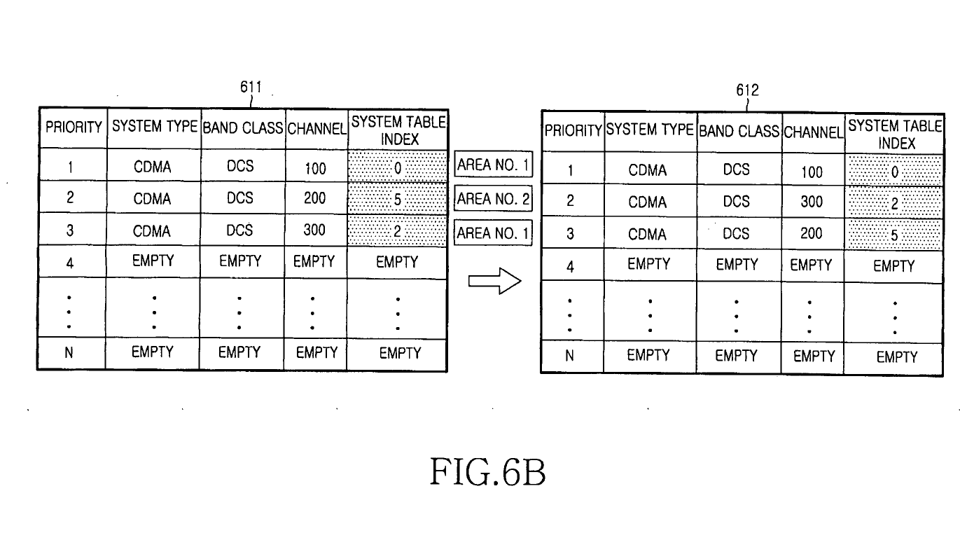

FIGS. 6A and 6B illustrate an example of a method of reordering the MRU table in accordance with the present invention.

A system table of the PRL of FIG. 6A is constructed with SID, NID, NEG-PREF, GEO, PRI, ACQ_INDEX and ROAM_IND fields on the horizontal axis and an area number on the vertical axis.

When the system table of the PRL is configured as indicated by reference numeral 610, ‘NEW’ of the ‘GEO’ field of the system table of the PRL indicates the start of one area and ‘SAME’ indicates an area equal to that of a higher system. In the system table, it can be seen that Nos. 1 to 4 are mapped to one area and other numbers from No. 5 are mapped to another area.

When the MRU table stores information as indicated by reference numeral 611 of FIG. 6B, a most recently acquired system becomes a system of Priority No. 1. A system of Priority No. 3 belonging to the same area as the system of Priority No. 1 is replaced with Priority No. 2. A system positioned in Priority No. 2 is shifted to a position of Priority No. 3. Thus, systems within the same area can be first searched for as indicated by reference numeral 612 of FIG. 6B when a periodic ping search is applied. For example, the sequence of the MRU table is reordered such that an acquisition attempt is first made for an area of a most recently acquired system.

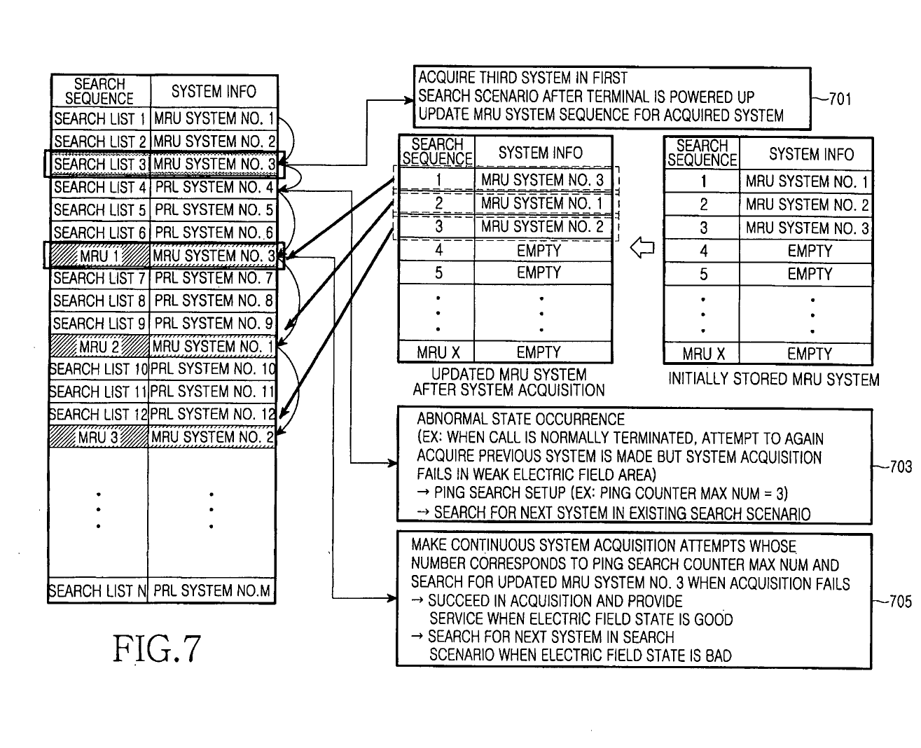

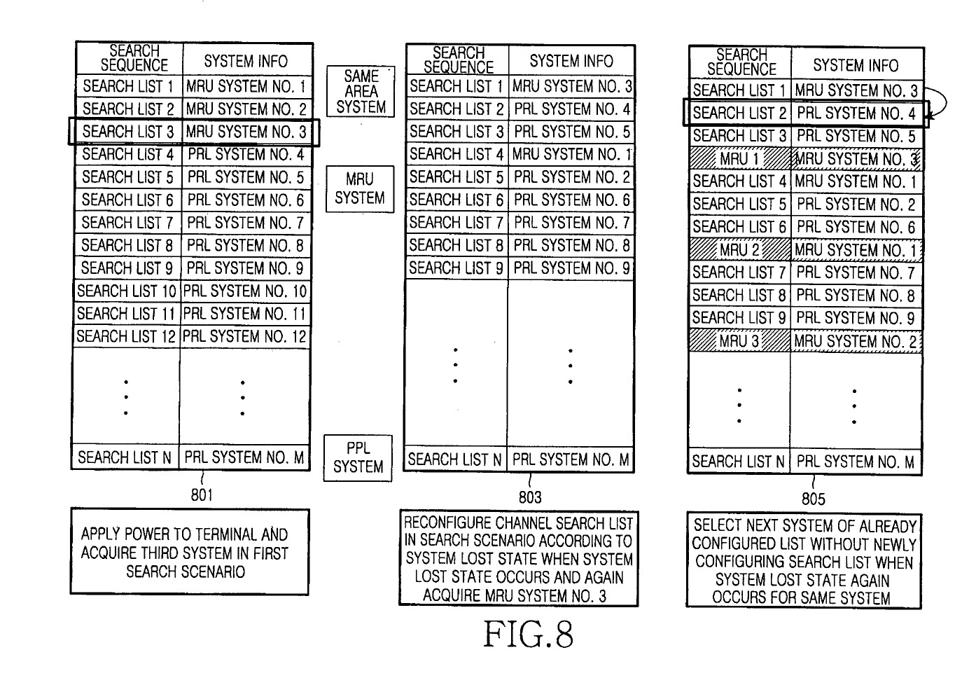

A system determination method in accordance the present invention is illustrated in FIGS. 7 and 8. First, an example in which an attempt to acquire the next system is made by selecting a system from an already configured search list will be described with reference to FIG. 7.

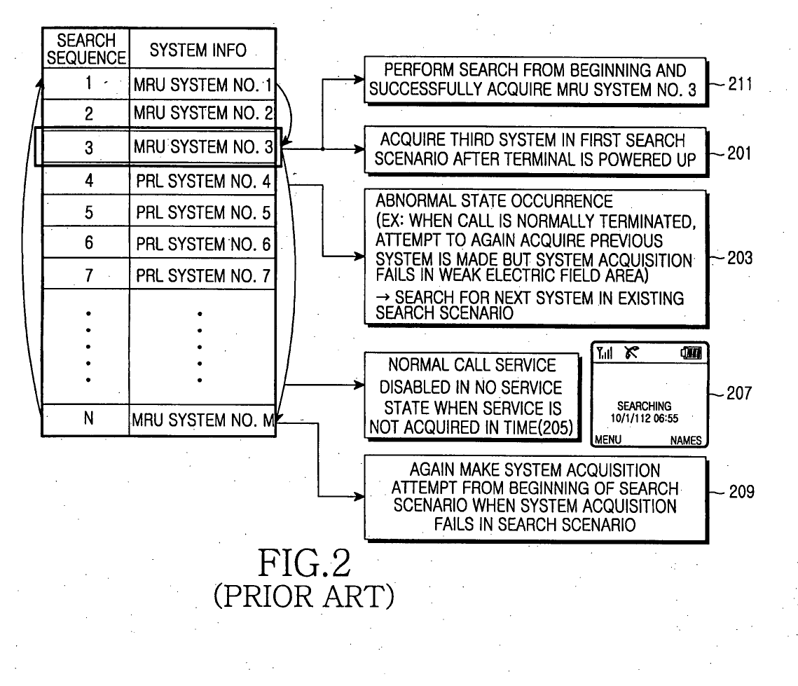

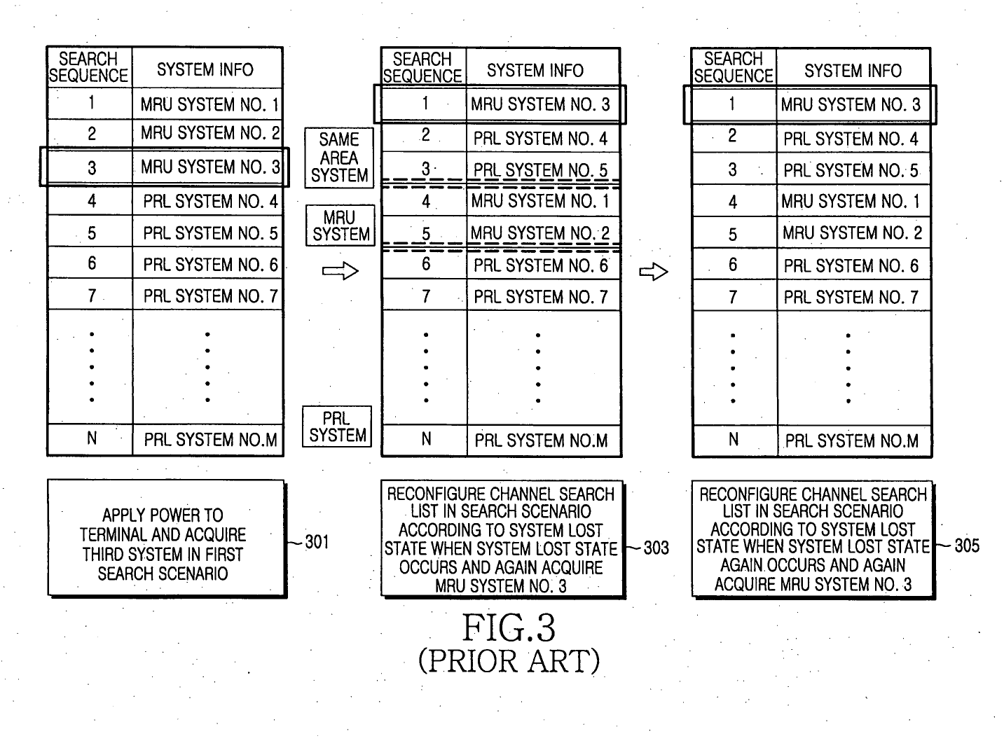

FIG. 7 further illustrates an example of a system search scheme in accordance with the present invention when system acquisition fails. The assumption as described above with reference to FIG. 2 is equally applied to FIG. 7.

In step 701, System No. 3 of the MRU table is acquired by sequentially retrieving a search list generated from the MRU table and the PRL after power is applied to the mobile terminal. A reordering process is performed using update information of the MRU table and geographic information of the system table of the PRL.

In step 703, an attempt to again acquire a previously acquired system is made before the mobile terminal returns to an initialization state when a phone call is made and terminated. However, the system acquisition fails due to an unstable signal level of the mobile terminal in a weak electric field area. In this case, a pin search, a ping counter and a maximum ping counter value are set and an attempt to acquire the next system in an existing search list is made. In step 703, the maximum ping counter value is set to 3. For example, a system of the MRU table is searched for after attempting to search for three systems in the search list.

In step 705, an attempt to search for MRU System No. 3 corresponding to the first system of the MRU table is made after a search for System Nos. 4, 5 and 6 of the search list fails. If an electric field state is good, the system acquisition can be successful. However, if the electric field state is still bad, an attempt to acquire the next system in the search list is made.

When the above-described method is applied, the present invention can provide a narrower interval at which systems of previous services are searched for in comparison with the conventional scheme. Moreover, the present invention can increase a probability of fast system acquisition by increasing the number of searches for the systems of the previous services.

FIG. 8 illustrates an example of a system search scheme in accordance with the present invention when a system is continuously lost and where a system acquisition attempt is made by configuring a new search scenario.

In step 801, a search list generated by the MRU table and the acquisition table of the PRL is sequentially retrieved when power is applied to the mobile terminal. System No. 3 of the MRU table is acquired.

In step 803, a search list is reconfigured according to search scenario when an acquired system is lost and a system lost indication is generated. Information of the previously acquired system is stored in a database. An attempt to again acquire MRU System No. 3 corresponding to the first system of the newly configured search list is made.

In step 805, system information previously stored in the database is compared with information of an acquired system currently lost without reconfiguring the search list as in the conventional scheme when the system is lost after the successful system acquisition and the system lost indication is generated. When the same system information is detected, a ping search is set, a ping counter value is initialized, a maximum ping counter value is set and an attempt to acquire the next system of the existing search list is made.

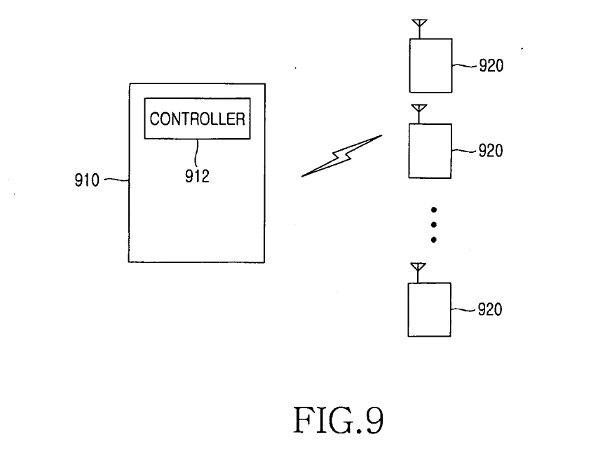

FIG. 9 is a block diagram illustrating a system determination apparatus for use in a mobile terminal in accordance with the present invention.

When the mobile terminal 910 is powered up to determine a system (or base station) 920, a controller 912 reads system information included in an acquisition table of a PRL and MRU system information included in an MRU table from a memory, generates a search list using the read information, and determines whether a ping counter is applied through the generated search list. If the ping counter is applied, the controller 912 determines whether a ping counter value is equal to a maximum ping counter value. If the ping counter value is equal to the maximum ping counter value, the controller 912 initializes the ping counter value, selects a system from the MRU table and makes a system acquisition attempt.

When a system has been lost, the controller 912 of the mobile terminal 910 determines whether a previously lost system is equal to a currently lost system. If the previously lost system is equal to the currently lost system, the controller 912 sets a ping search, initializes the ping counter, sets the maximum ping counter value and determines whether the ping counter is applied through a previously configured search list. If the ping counter is applied, the controller 912 determines whether the ping counter value is equal to the maximum ping counter value. If the ping counter value is equal to the maximum ping counter value, the controller 912 initializes the ping counter value, selects a system from the MRU table and makes a system acquisition attempt.

When a call is terminated, the controller 912 of the mobile terminal 900 sets the ping search, initializes the ping counter, sets the maximum ping counter value and makes an attempt to again acquire a previously acquired system.

When the present invention is applied, an opportunity to search for another system can be obtained when a system lost indication is continuously generated for the same system. Moreover, a system acquisition probability can increase since a fast ping search for a previously lost system can be periodically performed.

As is apparent from the above description, the present invention has at least the following advantages:

The present invention can again acquire a system in a shortened time when the mobile terminal has lost an acquired system or system acquisition has failed in a situation, for example, a weak electric field area, by improving a convention system search scheme.

Moreover, the present invention can efficiently select a system in a mobile terminal.

Moreover, the present invention can perform an efficient system search by introducing a ping search concept to periodically search for systems of an MRU table.

Moreover, the present invention can reduce a probability of occurrence of a ‘No Service’ state by periodically frequently searching for systems since a possibility of again acquiring systems of an MRU table from which a service has been previously provided is high when a system search is performed using an already configured search list or a search list of a new search scenario due to an abnormal state occurred in a mobile terminal.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A method for determining a system in a mobile terminal, comprising:
reading system information comprised in an acquisition table of a preferred roaming list (PRL) and most recently used (MRU) system information comprised in an MRU table from a memory when power is applied to the mobile terminal, and generating a search list using the read information;
determining whether a ping counter is applied through the generated search list;
determining whether a ping counter value is equal to a maximum ping counter value if the ping counter is applied; and
initializing the ping counter value, selecting a system from the MRU table and making a system acquisition attempt, if the ping counter value is equal to the maximum ping counter value.

2. The method of claim 1, further comprising:
determining whether the ping counter is applied through a ping search flag value.

3. The method of claim 1, further comprising:
incrementing the ping counter, selecting a system from the search list and making a system acquisition attempt, if the ping counter value is different from the maximum ping counter value.

4. The method of claim 1, further comprising:
determining whether system acquisition is successful;
receiving a synchronous channel message and an overhead message if the system acquisition is successful and determining whether at least one of a system identifier (SID) and a network identifier (NID) of the received messages matches that of a system table of the PRL; and
providing a service by entering an idle state if the at least one of the SID and the NID of the received messages matches that of the system table of the PRL.

5. The method of claim 4, further comprising:
setting a ping search, initializing the ping counter value and setting the maximum ping counter value, if the at least one of the SID and the NID of the received messages does not match that of the system table of the PRL.

6. The method of claim 4, further comprising:
providing the service by entering the idle state; and
setting the ping search to be disabled, updating information of the MRU table and reordering a sequence of geographic information using information of the system table of the PRL currently acquired.

7. A method for determining a system in a mobile terminal, comprising:
determining whether a previously lost system is equal to a currently lost system when the mobile terminal has lost a system;
setting a ping search, initializing a ping counter and setting a maximum ping counter value, if the previously lost system is equal to the currently lost system;
determining whether the ping counter is applied through a previously configured search list;
determining whether a ping counter value is equal to the maximum ping counter value if the ping counter is applied; and
initializing the ping counter value, selecting a system from a most recently used (MRU) table and making a system acquisition attempt, if the ping counter value is equal to the maximum ping counter value.

8. The method of claim 7, further comprising:
determining whether the ping counter is applied through a ping search flag value.

9. The method of claim 7, further comprising:
generating a search list using the MRU table and a preferred roaming list (PRL) if the previously lost system is different from the currently lost system;
storing information of the lost system;
determining whether the ping counter is applied through the generated search list;
determining whether the ping counter value is equal to the maximum ping counter value if the ping counter is applied; and
initializing the ping counter value, selecting the system from the MRU table and making the system acquisition attempt, if the ping counter value is equal to the maximum ping counter value.

10. The method of claim 9, further comprising:
incrementing the ping counter, selecting a system from the search list and making a system acquisition attempt, if the ping counter value is different from the maximum ping counter value.

11. The method of claim 7, further comprising:
determining whether system acquisition is successful;
receiving a synchronous channel message and an overhead message if the system acquisition is successful and determining whether at least one of a system identifier (SID) and a network identifier (NID) of the received messages matches that of a system table of a preferred roaming list (PRL); and
providing a service by entering an idle state if the at least one of the SID and the NID of the received messages matches that of the system table of the PRL.

12. The method of claim 11, further comprising:
setting the ping search, initializing the ping counter value and setting the maximum ping counter value, if the at least one of the SID and the NID of the received messages does not match that of the system table of the PRL.

13. The method of claim 11, further comprising:
providing the service by entering the idle state; and
setting the ping search to be disabled in the mobile terminal, updating information of the MRU table and reordering a sequence of geographic information using information of the system table of the PRL currently acquired.

14. A method for determining a system in a mobile terminal, comprising:
setting a ping search, initializing a ping counter value and setting a maximum ping counter value, when a call of the mobile terminal is terminated; and
attempting to again acquire a previously acquired system.

15. The method of claim 14, further comprising:
determining whether system acquisition is successful;
receiving a synchronous channel message and an overhead message if the system acquisition is successful and determining whether at least one of a system identifier (SID) and a network identifier (NID) of the received messages matches that of a system table of a preferred roaming list (PRL); and
providing a service by entering an idle state if the at least one of the SID and the NID of the received messages matches that of the system table of the PRL.

16. The method of claim 15, further comprising:
setting the ping search, initializing the ping counter value and setting the maximum ping counter value, if the at least one of the SID and the NID of the received messages does not match that of the system table of the PRL.

17. The method of claim 15, further comprising:
providing the service by entering the idle state; and
setting the ping search to be disabled in the mobile terminal, updating information of a most recently used (MRU) table and reordering a sequence of geographic information using information of the system table of the PRL currently acquired.

18. An apparatus for determining a system in a mobile terminal, comprising:
a controller for reading system information comprised in an acquisition table of a preferred roaming list (PRL) and most recently used (MRU) system information comprised in an MRU table from a memory when power is applied to the mobile terminal, generating a search list using the read information, determining whether a ping counter is applied through the generated search list, determining whether a ping counter value is equal to a maximum ping counter value if the ping counter is applied, and initializing the ping counter value, selecting a system from the MRU table and making a system acquisition attempt, if the ping counter value is equal to the maximum ping counter value.

19. The apparatus of claim 18, wherein the controller determines whether the ping counter is applied through a ping search flag value.

20. The apparatus of claim 18, wherein the controller increments the ping counter, selects a system from the search list and makes a system acquisition attempt, if the ping counter value is different from the maximum ping counter value.

21. The apparatus of claim 18, wherein the controller determines whether system acquisition is successful, receives a synchronous channel message and an overhead message if the system acquisition is successful, determines whether at least one of a system identifier (SID) and a network identifier (NID) of the received messages matches that of a system table of the PRL, and provides a service by entering an idle state if the at least one of the SID and the NID of the received messages matches that of the system table of the PRL.

22. The apparatus of claim 21, wherein the controller sets a ping search, initializes the ping counter value and sets the maximum ping counter value, if the at least one of the SID and the NID of the received messages does not match that of the system table of the PRL.

23. The apparatus of claim 21, wherein the controller sets the ping search to be disabled when providing the service by entering the idle state, updates information of the MRU table and reorders a sequence of geographic information using information of the system table of the PRL currently acquired.

24. An apparatus for determining a system in a mobile terminal, comprising:
a controller for determining whether a previously lost system is equal to a currently lost system when the mobile terminal has lost a system, setting a ping search, initializing a ping counter and setting a maximum ping counter value, if the previously lost system is equal to the currently lost system, determining whether the ping counter is applied through a previously configured search list, determining whether a ping counter value is equal to the maximum ping counter value if the ping counter is applied, and initializing the ping counter value, selecting a system from a most recently used (MRU) table and making a system acquisition attempt, if the ping counter value is equal to the maximum ping counter value.

25. The apparatus of claim 24, wherein the controller determines whether the ping counter is applied through a ping search flag value.

26. The apparatus of claim 24, wherein the controller generates a search list using the MRU table and a preferred roaming list (PRL) if the previously lost system is different from the currently lost system, stores information of the lost system, determines whether the ping counter is applied through the generated search list, determines whether the ping counter value is equal to the maximum ping counter value if the ping counter is applied, and initializes the ping counter value, selects the system from the MRU table and makes the system acquisition attempt, if the ping counter value is equal to the maximum ping counter value.

27. The apparatus of claim 26, wherein the controller increments the ping counter, selects a system from the search list and makes a system acquisition attempt, if the ping counter value is different from the maximum ping counter value.

28. The apparatus of claim 24, wherein the controller determines whether system acquisition is successful, receives a synchronous channel message and an overhead message if the system acquisition is successful, determines whether at least one a system identifier (SID) and a network identifier (NID) of the received messages matches that of a system table of a preferred roaming list (PRL), and provides a service by entering an idle state if the at least one of the SID and the NID of the received messages matches that of the system table of the PRL.

29. The apparatus of claim 28, wherein the controller sets the ping search, initializes the ping counter value and sets the maximum ping counter value, if the at least one of the SID and the NID of the received messages does not match that of the system table of the PRL.

30. The apparatus of claim 28, wherein the controller sets the ping search to be disabled in the mobile terminal when providing the service by entering the idle state, updates information of the MRU table and reorders a sequence of geographic information using information of the system table of the PRL currently acquired.

31. An apparatus for determining a system in a mobile terminal, comprising:
a controller for setting a ping search, initializing a ping counter value and setting a maximum ping counter value, when a call of the mobile terminal is terminated, and attempting to again acquire a previously acquired system.

32. The apparatus of claim 31, wherein the controller determines whether system acquisition is successful, receives a synchronous channel message and an overhead message if the system acquisition is successful, determines whether at least one of a system identifier (SID) and a network identifier (NID) of the received messages matches that of a system table of a preferred roaming list (PRL), and provides a service by entering an idle state if the at least one of the SID and the NID of the received messages matches that of the system table of the PRL.

33. The apparatus of claim 32, wherein the controller sets the ping search, initializes the ping counter value and sets the maximum ping counter value, if the at least one of the SID and the NID of the received messages does not match that of the system table of the PRL.

34. The apparatus of claim 32, wherein the controller sets the ping search to be disabled in the mobile terminal when providing the service by entering the idle state, updates information of a most recently used (MRU) table and reorders a sequence of geographic information using information of the system table of the PRL currently acquired.
